(19) United States
(12) Patent Application Publication
(10) Pub. No.: US 2010/0164220 A1
(43) Pub. Date: Jul. 1, 2010

(54) Secure Identification Document and Method for Producing It

(75) Inventor: Toni Kaskiala, Helsinki (FI)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: GEMALTO OY, Vantaa (FI)

(21) Appl. No.: 12/530,906

(22) PCT Filed: Mar. 7, 2009
(86) PCT No.: PCT/IB08/00537

§ 371 Date: Feb. 25, 2010

(30) Foreign Application Priority Data
Mar. 12, 2007 (EP) 07005017.4

(51) Int. Cl. B42D 15/10; B23K 26/36

(52) U.S. Cl. 283/108; 219/121.69

(57) ABSTRACT

The invention relates to a secure identification document having two main surfaces (S1, S2; S3,S4) and at least one edge, and comprising at least two constitution layers (20,22; 24,26), said identification document allowing preventing any separation of its constitution layers, by delamination for example, said separation being otherwise immediately apparent. The solution of the invention relates to the fact that the at least one edge of the identification document is marked with written data (23; 27) that are etched into said edge by means of a laser beam, said written data overlapping said constitution layers (20,22;24,26; 32,33,34), in order to prevent a fraudulent delamination of said document.

### BACKGROUND

This invention relates generally to identification documents and a method for making such identification documents. More particularly, this invention relates to a secure identification document that allows revealing a fraudulent manipulation consisting in the separation and the combination of different elements together, and a method for making such a document.

Identification documents, such as driving licenses, identity cards, membership cards, badges or passes, passports, discount cards, banking cards, money cards, multi-application cards, and other papers of value; and security documents such as bank notes are widely used. Because of the value and importance associated with each of these data carriers, they are often the subject of unauthorized copying and alterations, and forgeries.

Identification documents C1, C2 of prior art are schematized in cross-sectional view in FIG. 1. Such documents, which may have a shape of a passport or a card or a token, comprise at least two constitution layers 10, 12; 13, 15 respectively. The first layer 10 of document C1, respectively 13 of document C2, comprises markings 11, respectively 14. These markings 11; 14 may include, but are not limited to, personalized information and data, such as name, date of birth, address, personal number, signature, portrait, an hologram, a fingerprint, or an iris scan, etc. . . . The second layer 12 of document C1; respectively the second layer 15 of document C2, may include, but is not limited to, a contactless module for example.

The third document C3, which is schematized in FIG. 1, is a counterfeited document. Indeed, it comprises two layers. The first layer 10 is the same as the first layer of document C1, with altered markings 11′ for example. The second layer 15 is the same as the second layer of document C2 in its original format. This counterfeiting consists in combining two different identification documents into one. This can be done for example by delaminating the constitution layers 10, 12, 13, 15 of the documents C1, C2, and then by re-assembling some of the different layers 10 and 15 to make a new counterfeited document C3.

To prevent such activities from being carried out on these identification documents, different types of security features have been added to identification documents.

One prior art method of making a security feature involves performing a perforation pattern comprising holes with different sizes. The perforation pattern may be a photography for example. Each hole extends over a part of the document, i.e. through one or more constitution layers, the depth and/or shape of each hole being predetermined in accordance with the image to be displayed. In this case, if a fraudulent person tries to remove a layer in order to reuse it in a counterfeited document, some holes, each having a different depth and/or a different shape, are apparent and it becomes very difficult to make another counterfeited perforation pattern by reusing existing holes.

Another prior art method of making a security feature consists in using a chemically and mechanically tamper-proof material in zones of the constitution layers, in order to strongly stick the constitution layers and prevent any separation, by delamination or other means. These zones are piles of holes provided in each constitution layers, and holes are filled with the tamper-proof material, which can be made of epoxy glue, UV activated glue, benzo-cyclo-butene glue, polyimide glue, or plastic or metallic rivet for example. In this case, the tamper-proof rivets, which are made through the whole thickness of the constitution layers are visible and remain visible if one of these layers is reused. Moreover, it becomes very difficult to separate the layers, which are strongly affixed together, without damaging them.

However, all of these existing methods require more than one additional step that is time consuming and cost increasing.

Moreover, these methods don't prevent the use of a cover layer to hide the reused layer with its holes; said reused layer can contain a module for example. Such a cover layer can be personalized with falsified data.

Considering the above, a problem intended to be solved by the invention is to provide a secure identification document having two main surface and at least one edge, and comprising at least two constitution layers, said identification document allowing preventing any separation of its constitution layers, by delamination for example, said separation being otherwise immediately apparent.

### SUMMARY

The solution of the invention to this problem relates to the fact that the edge of the identification document is marked with written data that are etched into said edge by means of a laser beam, said written data overlapping said constitution layers, in order to prevent a fraudulent delamination of said document.

Thus, data are written so that they overlap whole edge of the document, the edge being formed by the at least two constitution layers of the document. Consequently, if the constitution layers are separated, by fraudulent delamination for example, then a part of the data will remain on each of the layers. With this solution, the fraudulent separation of the layers is immediately apparent, and it is no more possible to combine one of the layers with another layer of another document, because the fraudulent combination will be detected thanks to the differences between data written on the layers, said data of each layer being no more coherent and not continuously marked.

According to another aspect of the invention, there is provided a method for securing identification document, said document having two main surfaces and at least one edge, and comprising at least two constitution layers. This method is characterized by the fact that it comprises the step of etching said edge by means of a laser beam, so as to written data, which overlap said constitution layers, in order to prevent a fraudulent delamination.

Other aspects and advantages of the invention will become apparent from the following detailed description, taken in conjunction with the accompanying drawings, illustrating by way of example the principles of the invention.

### BRIEF DESCRIPTION OF DRAWINGS

The invention will be better understood with reference to the drawings, in which:

FIG. 1, already described, illustrates schematic cross-sectional views of two identification documents of prior art and a third counterfeited identification document,

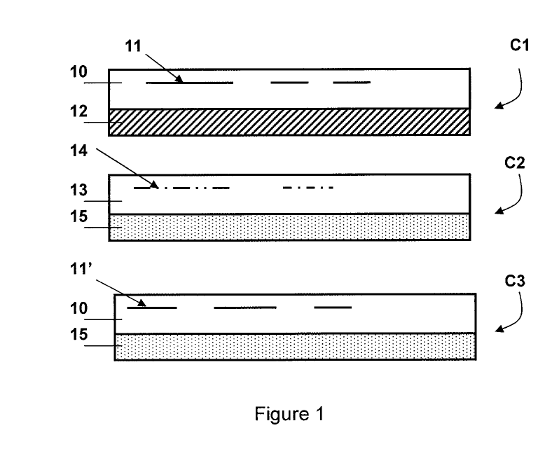

FIG. 2 illustrates schematic perspective views of two identification documents according to the invention and a third counterfeited identification document, on which the fraud appears immediately,

FIGS. 3A and 3B are schematic views of an edge of respectively an identification document according to the invention and a counterfeited identification document, whose constitution layers have been secured according to the invention.

### DETAILED DESCRIPTION

Hereafter, an embodiment of the present invention will be described in the context of identity (ID) card and a method for producing it. However, it is to be understood that the invention is usable with any data carrier that includes, but is not limited to, a driving license, a badge or pass, a passport, a discount card, a membership card, a banking card, a credit card, a money card, a multi-application card, and other security documents and papers of value that are to be provided with information or data in such a way that they cannot be easily imitated by common means.

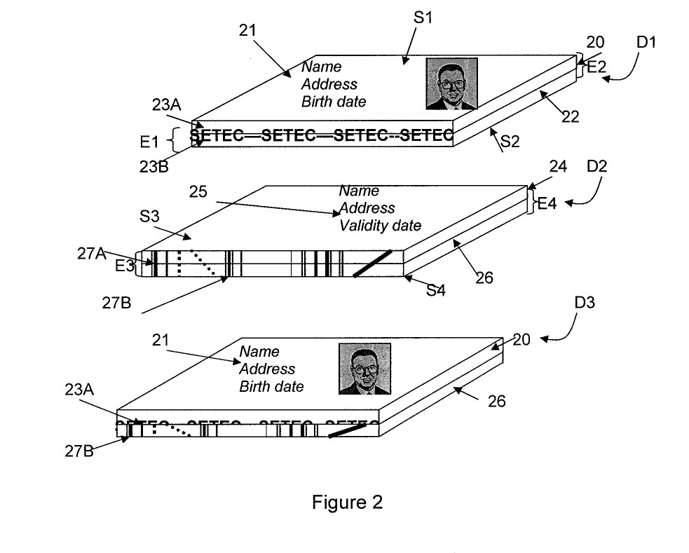

FIG. 2 shows a first and a second identification document D1, D2 according to the invention. Such identification document comprises at least two constitution layers 20, 22, respectively 24, 26, that are assembled together, by lamination technology for example. They have two main external surfaces S1, S2, respectively S3, S4, and at least one edge E1, E2, respectively E3, E4.

At least the main external surface S1 of the first layer 20 of document D1, respectively surface S3 of the first layer 24 of document D2, comprises markings 21, respectively 25. These markings 21; 25 may include, but are not limited to, personalized information and data, such as name, date of birth, address, personal number, signature, portrait, an hologram, a fingerprint, or an iris scan, etc . . . . The second layer 22 of document D1; respectively the second layer 26 of document D2, may include, but is not limited to, a contactless module for example.

In order to prevent any separation of the constitution layers of these documents, at least one of the four edges of each of the documents D1, D2 are marked with written data 23, 27. These data may include, but are not limited to, personalized information, such as a logo of a company, text, lines, bar codes etc . . . . The marking step of the edge is managed in such a manner that the data overlap the constitution layers of the whole edge and draw a continuous text or logo or line or bar code etc . . . . Thus, a part 23A, respectively 27A, of the data is marked on the first constitution layer 20, respectively 24, while another part 23B, 27B, of the data is marked on the second constitution layer 22, respectively 26.

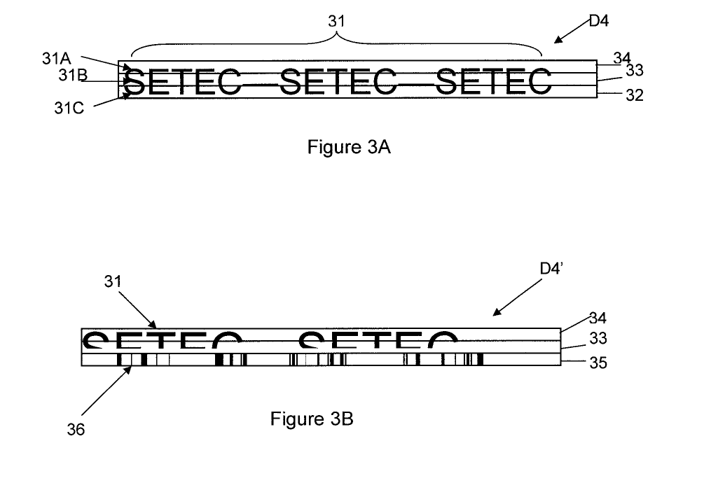

FIG. 3A shows such an edge of an identification document D4. In this illustrated example, the document comprises three constitution layers 32, 33, 34, and the name Setec 31 is written on the edge in such a manner that the text overlaps all the three constitution layers. In this case, layer 34 comprises an upper part 31A of the name setec, layer 33 comprises an intermediate part 31B of the name setec, while layer 32 comprises a lower part 31C of the name setec.

Thanks to this marking of at least one edge of the identification document, any fraud consisting in separating constitution layers of two original documents D1, D2 and assembling at least two of them, for example layer 20 of D1 and layer 26 of D2, for making a counterfeited document D3, will be immediately apparent. Indeed, in this case, the part 23A of data marked on the side of the first layer 20 of the counterfeited document D3 is no more continuous with part 27B of data marked on the side of the second layer 26.

FIG. 3B illustrates the edge of such counterfeited document D4′, where the original layer 32 has been replaced by a layer 35 of another document. It appears that the written data are no more continuously marked and written data are completely incoherent and no more readable. Thus, the fraud appears immediately.

Thus, such markings on the edge enhance the protection of the document against fraudulent delamination or other splitting. This is particularly important for contactless cards or datapages of passport for example, which contain at least a chip and an antenna inside.

The marking step may be made for example by printing technology, such as dye sublimation printing referred commonly to in the industry as D2T2, or by laser etching for example. However, the embodiment of laser etching is preferred compared with printing, because laser etching or laser engraving is a destructive and irreversible technique, which is more difficult to reproduce or to alter than the printing, which is a technology based on material addition. Mechanical processing methods can also be used, such as grinding or polishing, but they are not as accurate as a technology using lasering.

Laser beam may be used either to remove or etching material, or to change the material by burning it for example. In both cases, data are written in an irreversible manner. Nevertheless, etching is preferred because this technology does not leave burning marks. For removing material, the laser beam used can be, but is not limited to, a short pulse laser using for example UV beam. Such a laser beam happens so fast that the material is sublimated and does not leave material on the surface, which remains very clean. The temperature on the exposed surface does not arise because the duration of the marking step is very short. Such laser beam has shown excellent and accurate results for marking the edges of datapages of passport and of smart cards. Moreover, the etching of the edge of the document, i.e. material removal from the surface of the edge, with or without color changes to the surface is necessary in order to protect the markings that are etched against wearing out from the edges. The marking step is advantageously made on a finished product, at a final stage after the complete manufacture of the identification document. Consequently, this marking step may be made either by the manufacturer, or by its customer, or by a third company.

Thickness of the edges of identification documents varies and depends essentially on the number and thickness of its constitution layers. Generally, the thickness of an identification document is more than 200 μm. The edges of identification documents are marked either by etching, i.e removing material of, or by burning the material of the constitution layers with a laser beam.

Constitution layers are made of laser-markable material. They can be made of paper or plastic material. If they are fabricated of plastic material, it can be materials customary in card manufacturing, such as polycarbonate (PC) with carbon particles therein. Other materials such as Polyethylene terephtalate (PET), Polyvinyl chloride (PVC), Acrylonitrile Butadiene Styrene (ABS), Polyurethane (PU) or a Silica-based polymer commercialized under the registered trademark “Teslin” may also be used so long as they are able to absorb the energy of the laser beam for creating marking thereat.

The thus described embodiment increases the security of identification documents and prevents reassembling of separated constitution layers.

1-4. (canceled)

5. A secure identification document comprising:
two main surfaces,
at least one edge, and
at least two constitution layers,
wherein the edge is marked with written data etched into the edge by a laser beam, the written data overlapping the constitution layers, in order to prevent a fraudulent delamination of the document.

6. The secure identification document according to claim 5, wherein the written data are selected from personalized text, logo, lines, and bar codes.

7. The secure identification document according to claim 5, wherein each of the constitution layers comprises a material selected from paper, polycarbonate, polyethylene terephtalate, polyvinyl chloride, acrylonitrile butadiene styrene (ABS), polyurethane (PU), and a silica-based polymer.

8. The secure identification document according to claim 6, wherein each of the constitution layers comprises a material selected from paper, polycarbonate, polyethylene terephthalate, polyvinyl chloride, acrylonitrile butadiene styrene (ABS), polyurethane (PU), and a silica-based polymer.

9. A method for securing an identification document, the document comprising two main surfaces, at least one edge, and at least two constitution layers, the method comprising:
etching the edge by a laser beam to provide written data overlapping the constitution layers, in order to prevent a fraudulent delamination.
